(19) United States
(12) Patent Application Publication
(10) Pub. No.: US 2013/0265374 A1
(43) Pub. Date: Oct. 10, 2013

(54) PRINTING LIQUID FILLED CONTAINER AND IMAGE FORMING APPARATUS

(71) Applicant: FUJIFILM CORPORATION, Tokyo (JP)

(72) Inventor: Masahiko Kondou, Ashigarakami-gun (JP)

(21) Appl. No.: 13/906,360

(22) Filed: May 31, 2013

Related U.S. Application Data
(63) Continuation of application No. PCT/JP2011/077733, filed on Nov. 24, 2011.

(30) Foreign Application Priority Data
Dec. 20, 2010 (JP) 2010-283433

(51) Int. Cl. B41J 2/175

(52) U.S. Cl. CPC B41J 2/17536
USPC 347/86

(57) ABSTRACT

A liquid for printing and a gas are filled in a liquid housing section of a liquid pack configured by a flexible material that can let liquid flow out from an opening without gas-liquid replacement. The gas fill volume is 0.059 or greater with respect to a containable volume capacity of the liquid housing section being 1.

### CROSS-REFERENCE TO RELATED APPLICATIONS

This application is a continuation application of International Application No. PCT/JP2011/077733, filed Nov. 24, 2011, the disclosure of which is incorporated herein by reference in its entirety. Further, this application claims priority from Japanese Patent Application No. 2010-283433, filed Dec. 20, 2010, the disclosure of which is incorporated herein by reference in its entirety.

### BACKGROUND

1. Technical Field

The present invention relates to a printing liquid filled container and an image forming apparatus.

2. Related Art

A known example of an image forming apparatus, such as a printer, facsimile, copying machine, plotter or multi-function machine thereof, is an image forming apparatus that employs a liquid droplet jetting recording method to jet a printing liquid, such as for example ink, as liquid droplets using a recording head.

There are examples of such an image forming apparatus using a liquid droplet jetting recording method in which a liquid is supplied from a printing liquid filled container to a recording head and/or a main tank in communication with the recording head.

Printing liquid filled containers exist with containers capable of containing large volumes of liquid for printing. The main body of such containers is configured from a flexible material and the container is installed in an image forming apparatus with an opening facing downwards. The liquid flowing out from the opening under gravity can be supplied, such as to a main tank, without gas-liquid replacement since the volume of the container decreases according to the discharge volume.

However, in such containers, since the container collapses (reduces in volume) as liquid feeding progresses, depending on the manner of collapse liquid may be drawn into creases that form due to the collapsing, resulting in an increase in the amount of liquid remaining in the container.

There is a description in Japanese Patent Application Laid-Open (JP-A) No. 2003-136745 of a printing liquid filled container configured to supply ink as a liquid with a container main body formed from a flexible film such as polyethylene. In this configuration in addition to the ink the container main body is also filled with a non-reactive gas such as nitrogen or argon.

However, the configuration of JP-A No. 2003-136745 is filled with a non-reactive gas in order to facilitate re-filling when refilling an empty container from which ink has been discharged, and there is no reference made to reducing the liquid remaining.

### SUMMARY OF INVENTION

In consideration of the above circumstances the present invention is directed towards provision of a printing liquid filled container and an image forming apparatus that reduces the amount of liquid remaining in a container.

A printing liquid filled container according to a first aspect of the present invention includes: a container that is configured by a flexible material that can let liquid flow out from an opening without gas-liquid replacement and is filled with a liquid for printing and a gas, wherein the gas fill volume is 0.059 or greater with respect to a containable volume capacity of the container being 1.

### BRIEF DESCRIPTION OF DRAWINGS

Exemplary embodiments of the present invention will be described in detail based on the following figures, wherein:

FIG. 1 is a schematic diagram illustrating an overall configuration of an inkjet recording apparatus including a printing liquid filled container according to an exemplary embodiment of the present invention;

FIG. 2 is a perspective view illustrating a liquid supply device overall;

FIG. 3A and FIG. 3B are side views illustrating the interior of the seating sections shown in FIG. 2, and focusing on an operation lever, FIG. 3A illustrates the operation lever in a lowered position and FIG. 3B illustrates the operation lever in a raised position;

FIG. 4 is a cross-section illustrating a configuration of a hole piercing section;

FIG. 5A to FIG. 5C are perspective views of a tank unit, with FIG. 5A to FIG. 5C illustrating the tank unit as seen from three directions of changed angle;

FIG. 6A to FIG. 6C are perspective views of a carton adapter, with FIG. 6A to FIG. 6C illustrating the carton adapter as seen from three directions of changed angle;

FIG. 7 is a perspective view illustrating a carton unit;

FIG. 8 is diagram illustrating a liquid pack serving as a printing liquid filled container according to an exemplary embodiment of the present invention, as seen from 3 faces;

FIG. 9 is a cross-section of a carton unit in which a liquid pack is housed in a carton;

FIG. 10 is an explanatory diagram illustrating states when a carton unit is installed to a carton adaptor;

FIG. 11A and FIG. 11B are cross-sections illustrating details of a hole piercing section and a liquid pack opening, FIG. 11A is a cross-section illustrating the hole piercing section in a lowered position, in a state prior to being inserted into the opening of the liquid pack, and FIG. 11B is an explanatory diagram illustrating a state of a sealing member provided to the opening of the liquid pack when in the same state as that of FIG. 11A;

FIG. 12A and FIG. 12B are cross-sections illustrating details of a hole piercing section and a liquid pack opening, FIG. 12A is a cross-section illustrating the hole piercing section in a raised position, in an inserted state in the opening of the liquid pack, and FIG. 12B is an explanatory diagram illustrating a state of the sealing member when in the same state as that of FIG. 12A;

FIG. 13A to FIG. 13D are explanatory diagrams of operation according to an exemplary embodiment of the present invention, illustrating states of discharging liquid in the liquid pack from the opening;

FIG. 14 is a graph showing a relationship of amount of ink remaining against gas fill volume; and

FIG. 15A to FIG. 15D are explanatory diagrams of related technology showing states occurring when discharging liquid from a liquid pack opening.

### DETAILED DESCRIPTION

Specific explanation follows regarding a printing liquid filled container and an image forming apparatus according to a first exemplary embodiment of the present invention, with reference to the attached drawings. In the drawings members (configuration elements) having the same or corresponding function to each other are allocated the same reference numeral and further explanation is omitted as appropriate.

Overall Configuration

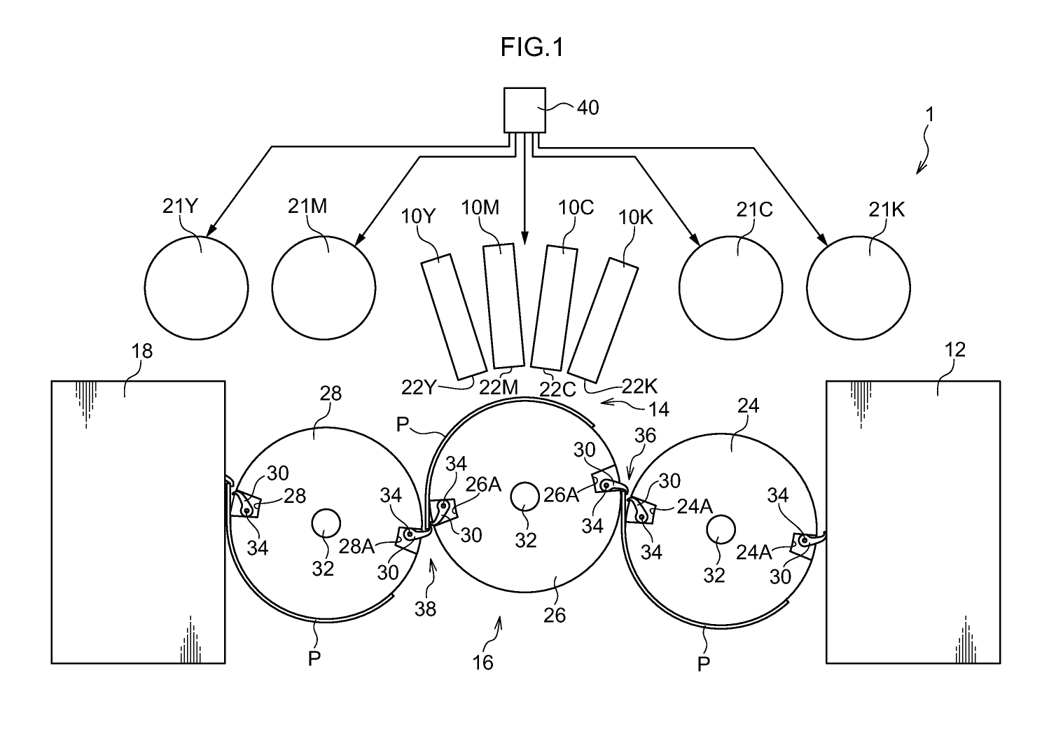

FIG. 1 is a schematic diagram illustrating an overall configuration of an inkjet recording apparatus including a printing liquid filled container according to an exemplary embodiment of the present invention.

As shown in FIG. 1, an inkjet recording apparatus 1 (corresponding to an image forming apparatus) includes: a recording medium housing section 12 for housing a recording medium P, such as paper; an image recording section 14 for recording an image on the recording medium P; a conveying means 16 for conveying the recording medium P from the recording medium housing section 12 to the image recording section 14; and a recording medium discharge section 18 for discharging recording medium P that has been recorded with an image in the image recording section 14.

The image recording section 14 includes liquid droplet jetting devices (referred to below as “inkjet heads”) 10Y, 10M, 10C, 10K, serving as examples of a liquid droplet jetting head for jetting liquid droplets (also corresponding to a head section), that jet ink droplets to record an image on a recording medium. In the following the inkjet heads 10Y, 10M, 10C, 10K will sometimes be referred to below collectively as “inkjet heads 10Y to 10K”.

The inkjet heads 10Y to 10K have respective nozzle faces 22Y to 22K formed with nozzles (not shown in the drawings). The nozzle faces 22Y to 22K have a recordable region that is of about the same size as, or greater than, the maximum width of the recording medium P anticipated to be image-recorded with the inkjet recording apparatus 1.

The inkjet heads 10Y to 10K are disposed next to each other in a row in the color sequence yellow (Y), magenta (M), cyan (C) and black (K), as listed from the recording medium P conveying direction downstream side. Configuration is made such that ink droplets of the respective corresponding color are jetted using a piezoelectric method from plural nozzles to record an image. A configuration using any other jetting method, such as a thermal jetting method, may be employed in the inkjet heads 10Y to 10K as a configuration for jetting ink droplets.

Main ink tanks 21Y, 21M, 21C, 21K (referred to below as main ink tanks 21Y to 21K) store ink of each of the colors and are provided as storage sections for storing liquid in the inkjet recording apparatus 1. Ink is fed from the main ink tanks 21Y to 21K to each of the respective inkjet heads 10Y to 10K. Note that various types of ink may be applied as the ink for feeding to the inkjet heads 10Y to 10K, such as water based inks, oil based inks and solvent based inks.

The conveying means 16 includes: a take-out drum 24 for taking out the recording medium P inside the recording medium housing section 12 one sheet at a time; a conveying drum 26 that conveys the recording medium P to the inkjet heads 10Y to 10K of the image recording section 14 and makes the recording face (front face) of the recording medium P face towards the inkjet heads 10Y to 10K; a feed-out drum 28 for feeding out to the recording medium discharge section 18 the image-recorded recording medium P. The take-out drum 24, the conveying drum 26 and the feed-out drum 28 are each configured to retain the recording medium P on their peripheral faces by employing an electrostatic attraction means and/or a non-electrostatic attraction means such as by using suction or adhesive.

The take-out drum 24, the conveying drum 26 and the feed-out drum 28 each have clippers 30 serving as retaining means for retaining the recording medium P by nipping a portion on the recording medium P conveying direction downstream edge. For example, the three drums 24, 26, 28 are provided with two sets of the clippers 30 each, and are configured so as to be capable of retaining up to two sheets of recording medium P on their respective peripheral faces using the clippers 30. The clippers 30 are provided inside two indentations 24A, 26A, 28A formed in the peripheral face of each of the drums 24, 26, 28.

More specifically, rotation shafts 34 are supported at predetermined positions in the indentations 24A, 26A, 28A of each of the drums 24, 26, 28 so as to align with the rotation axis 32 of each of the drums 24, 26, 28, and the plural clippers 30 are fixed to the rotation shafts 34 at intervals along the axial direction. Consequently, when the rotation shafts 34 are rotated in a forward or reverse direction by actuators, not shown in the drawings, the clippers 30 are also rotated in the forward or reverse direction along the circumferential direction of each of the drums 24, 26, 28 so as to either nip and retain or release portions at the recording medium P conveying direction downstream edge.

Namely, configuration is made such that by rotating the clippers 30 so that the leading end portions of the clippers 30 slightly project out from the peripheral faces of the drums 24, 26, 28, the recording medium P is passed across from the clippers 30 of the take-out drum 24 to the clippers 30 of the conveying drum 26 at a passing-across position 36 where the peripheral face of the take-out drum 24 and the peripheral face of the conveying drum 26 face each other. Similarly, the recording medium P is passed across from the clippers 30 of the conveying drum 26 to the clippers 30 of the feed-out drum 28 at a passing-across position 38 where the peripheral face of the conveying drum 26 and the peripheral face of the feed-out drum 28 face each other.

The inkjet recording apparatus 1 is also provided with a maintenance unit (not shown in the drawings) for maintaining the inkjet heads 10Y to 10K. The maintenance unit has various configuration elements such as a cap for covering the nozzle faces of the inkjet heads 10Y to 10K, a receiving member for receiving liquid droplets jetted in preparation (dummy jetting), a cleaning member for cleaning the nozzle faces and a suction device for suctioning ink inside the nozzles. The maintenance unit performs various types of maintenance operation by moving to a position facing towards the inkjet heads 10Y to 10K. The maintenance unit is supplied with a cleaning fluid, described later.

Explanation follows regarding image recording operation in the inkjet recording apparatus 1.

The recording medium P, taken out one sheet at a time from the recording medium housing section 12 and retained using the clippers 30 of the take-out drum 24, is conveyed while adhered to the peripheral face of the take-out drum 24, and passed across from the clippers 30 of the take-out drum 24 to the clippers 30 of the conveying drum 26 at the passing-across position 36.

The recording medium P now retained by the clippers 30 of the conveying drum 26 is then conveyed while adhered to the conveying drum 26 to the image recording position of each of the inkjet heads 10Y to 10K, and an image is recorded on the recording face of the recording medium P by ink droplets jetted from the respective inkjet heads 10Y to 10K.

The recording medium P that has been recorded with an image on the recording face is passed across from the clippers 30 of the conveying drum 26 to the clippers 30 of the feed-out drum 28 at the passing-across position 38. The recording medium P now retained by the clippers 30 of the feed-out drum 28 is then conveyed while adhered to the feed-out drum 28 and discharged into the recording medium discharge section 18. The above completes one cycle of image recording operations.

The main ink tanks 21Y to 21K are connected to a liquid supply device 40 of the present invention. The liquid supply device 40 supplies ink or cleaning fluid to the main ink tanks 21Y to 21K or to a liquid storage tank for supplying cleaning fluid to the maintenance unit.

Liquid Supply Device

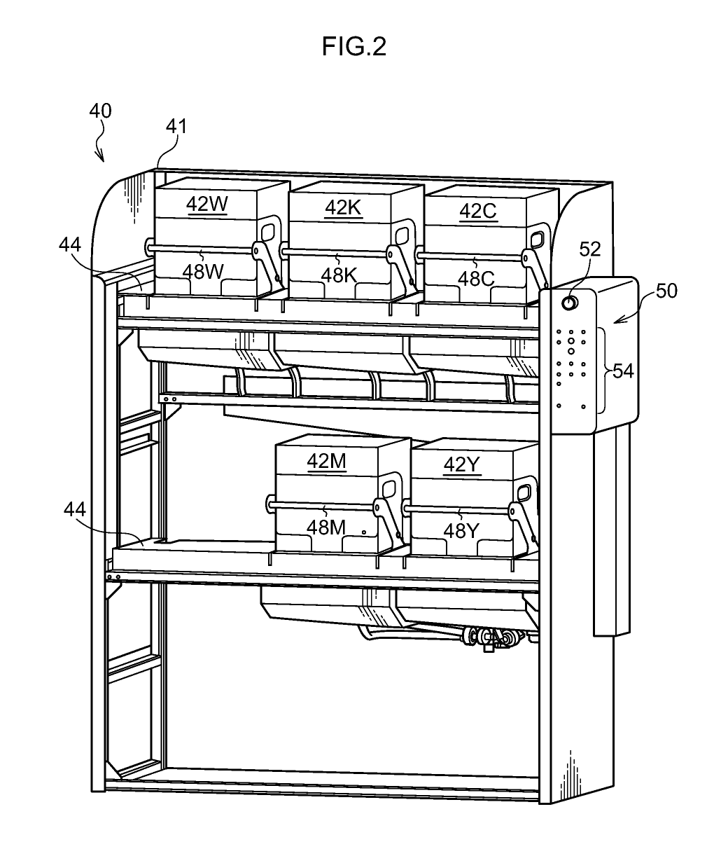

FIG. 2 is a perspective view illustrating an overall configuration of the liquid supply device 40.

The liquid supply device 40 is configured with a three-shelved casing body 41, and with five individual tank units 42Y, 42M, 42C, 42K, 42W provided to the casing body 41. The tank units 42Y, 42M, 42C, 42K, 42W are sometimes referred to collectively as “tank units 42Y to 42W”. The tank units 42Y to 42W are each formed as a substantially rectangular block shaped body.

The tank units 42Y, 42M, 42C, 42K are filled respectively with yellow, magenta, cyan and black inks, and the tank unit 42W is filled with a cleaning fluid. The tank units 42Y to 42W are attached to the casing body 41 so as to be detachable from seating sections 44 (corresponding to an installation section), and configure replaceable supply tanks for feeding liquid to their respective feed destinations.

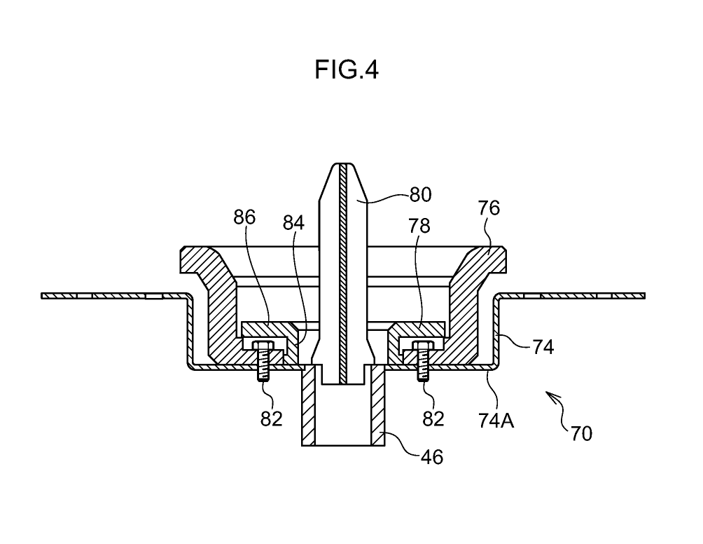

The tank unit 42Y and the tank unit 42M are provided (installed) on the middle tier seating section 44 of the casing body 41. The tank unit 42C, the tank unit 42K and the tank unit 42W are provided on the upper tier seating section 44 of the casing body 41. Distribution tubes 46 (corresponding to a liquid feed section and not shown in the FIG. 1. Refer to FIG. 4 described later) correspondingly connect together: the tank unit 42Y to the main ink tank 21Y; the tank unit 42M to the main ink tank 21M; the tank unit 42C to the main ink tank 21C; the tank unit 42K to the main ink tank 21K; and the tank unit 42W to the maintenance unit.

Each of the tank units 42Y to 42W are provided higher in the direction of gravity than their respective connection destinations (feed destinations), the main ink tanks 21Y to 21K or the maintenance unit. Ink or cleaning fluid is fed to the connection destination by utilizing the header difference.

Operation levers 48Y, 48M, 48C, 48K, 48W are provided to the seating sections 44 of the casing body 41 so as to correspond to the tank units 42Y to 42W. The operation levers 48Y, 48M, 48C, 48K, 48W are manipulated up or down in order to replace the tank units 42Y to 42W.

An operation panel 50 is attached to the casing body 41 in the vicinity of the upper right hand side. The operation panel 50 is equipped with an operation switch 52 and plural display lights 54. The corresponding display light 54 is illuminated whenever the ink in any of the main ink tanks 21Y to 21K or the cleaning fluid in the maintenance unit has decreased to a predetermined level, thereby prompting an operator to replace the corresponding tank unit(s) 42Y to 42W.

Since the configuration of each of the tank units 42Y to 42W is similar to each other, and the configuration of each of the operation levers 48Y to 48W is similar to each other, specific explanation will be given regarding one of each, the tank unit 42Y and the operation lever 48Y. Note that the suffix “Y” is omitted where appropriate.

Operation Lever

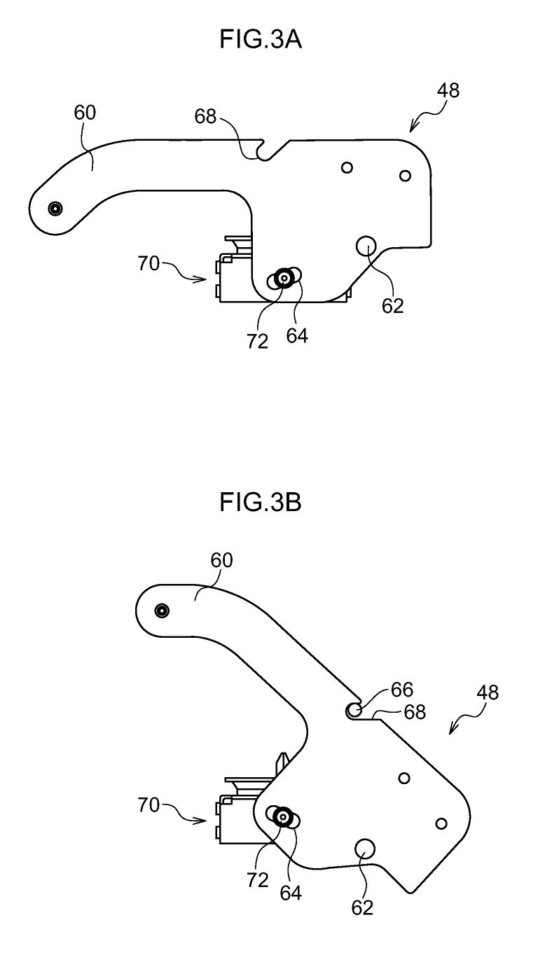

FIG. 3A and FIG. 3B are side views illustrating the interior of the seating section 44 shown in FIG. 2, and focusing on the operation lever 48. The operation lever 48 is shown in the lowered position in FIG. 3A and the operation lever 48 is shown in the raised position in FIG. 3B.

The operation lever 48 has two lever arms 60 (one is not visible in the drawings). Each of the lever arms 60 is supported by the seating section 44 through a rotation shaft 62, with the operation lever 48 capable of rotational operation about the rotation shaft 62. Each of the lever arms 60 is formed with an elongated hole 64 and a cutout groove 68 for engaging with an engaging pin 66, described later. The cutout groove 68 is formed along a circular circumference centered on the rotation shaft 62, and is configured to prevent the tank unit 42 from being removed while the cutout groove 68 is in an engaged state with the engaging pin 66.

A hole piercing section 70 that is disposed in a position in the seating section 44 facing the tank unit 42 is connected to the operation lever 48 configured as described above. The hole piercing section 70 is operated up or down according to the operation position of the operation lever 48. Specifically, the hole piercing section 70 is disposed between the two lever arms 60, with side end pins 72 that are provided on both side faces of the hole piercing section 70 connected to the operation lever 48 so as to fit into the elongated hole 64 formed on each of the lever arms 60. Rotational operation of the operation lever 48 moves the hole piercing section 70 up or down along two portal shaped guide members, not shown in the drawings, provided on the side faces of the hole piercing section 70.

The hole piercing section 70 is fitted into (inserted into) the tank unit 42 when the operation lever 48 is operated upwards, and sealing of the tank unit 42 is broken by the hole piercing section 70 so that liquid (ink) is able to be discharged from the tank unit 42.

FIG. 4 is a cross-section illustrating a configuration of the hole piercing section 70.

The hole piercing section 70 is configured with a base member 74, opening towards the top from a recess 74A provided to the base member 74, a surrounding member 76 provided so as to surround the opening, a bearing member 78 provided inside the surrounding member 76, and a hole piercing tool 80 disposed inside the bearing member 78.

The surrounding member 76 is fixed to the base member 74 by screws 82. A hole is pre-provided in the center of the bottom face of the surrounding member 76. A hole one size smaller than the hole in the surrounding member 76 is also pre-provided in the center of the bottom face of the recess 74A of the base member 74.

The bearing member 78 is formed from a rubber material in a substantially cylindrical shape overall, equipped with a cylinder portion 84 and a bearing portion 86 extending towards the outside from one end of the cylinder portion 84. The other end of the cylinder portion 84 is placed in close contact with the bottom of the recess 74A of the base member 74 and the bearing portion 86 is also placed in close contact with the bottom of the surrounding member 76. The hole formed by the recess 74A of the base member 74 is connected to one end of the distribution tube 46 for connection to the liquid feed destination. The base portion of the hole piercing tool 80 is attached to the end face of the distribution tube 46, thereby fixing the hole piercing tool 80 with the leading end portion of the hole piercing tool 80 in an upward facing orientation.

Tank Unit

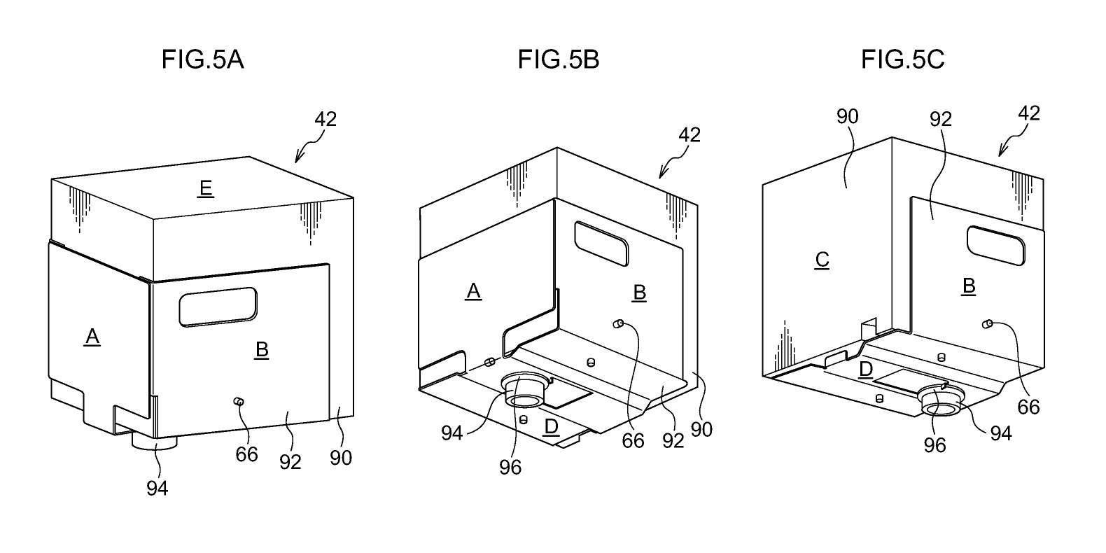

FIG. 5A to FIG. 5C are perspective views illustrating the tank unit 42. FIG. 5A, FIG. 5B and FIG. 5C each illustrate the tank unit 42 as viewed from 3 directions at changed angles.

The tank unit 42 is configured with a carton unit 90 and a carton adaptor 92 (corresponding to a surrounding member). In the drawings the face that faces the front when the tank unit is installed in the seating section (front face) is denoted A, B denotes side faces, C denotes the back face, D denotes the bottom face, and E denotes the top face. An opening 94 that becomes a liquid inlet-outlet and a hook portion 96 project out from the bottom face D.

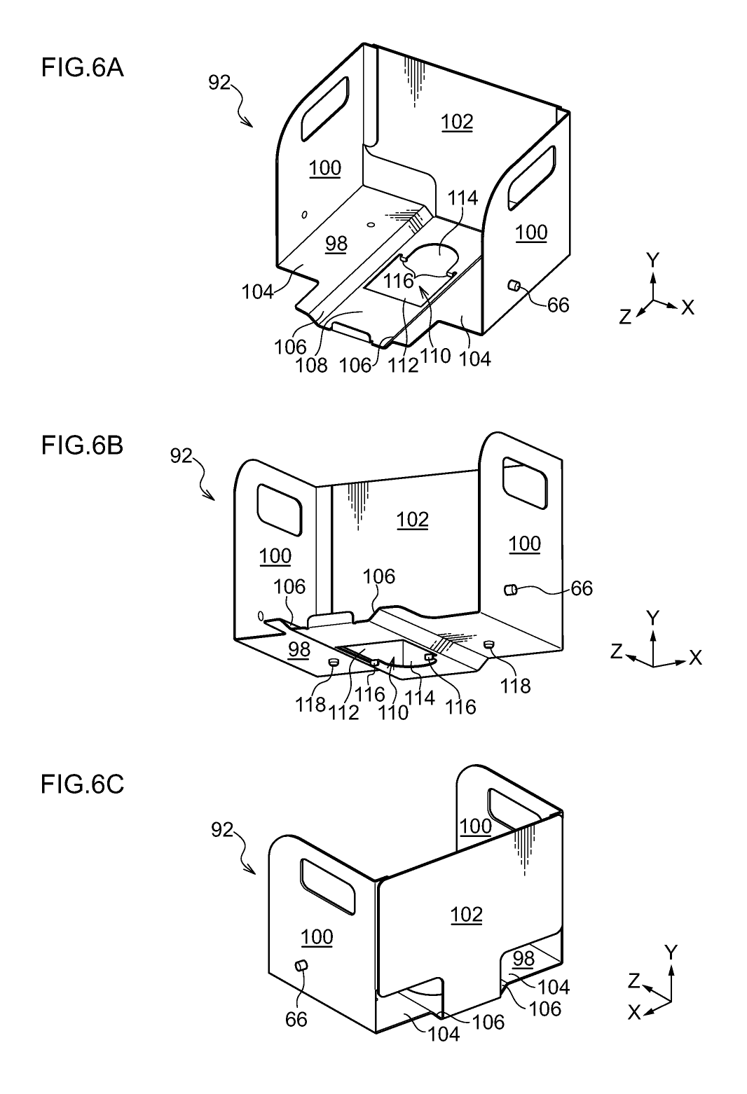

FIG. 6A to FIG. 6C are perspective views illustrating the carton adaptor 92. FIG. 6A, FIG. 6B and FIG. 6C each illustrate the carton adaptor 92 as viewed from 3 directions at changed angles.

The carton adaptor 92 is formed from thin sheet metal so as to configure a mutually orthogonal bottom plate 98, side plates 100 and front plate 102 surrounding four faces out of the six faces of the carton unit 90, the front face, both side faces and the bottom face.

The bottom plate 98 is provided with a support face 104 that supports the bottom face of the carton unit 90 (namely supports the bottom face of the liquid pack 130 (corresponding to a printing liquid filled container)), and a stepped face 108 provided so as to step down from the support face 104 with sloping portions 106 in between. An opening section 110 is formed in the stepped face 108 so as to allow the opening 94 of the liquid pack 130 pass through.

The opening section 110 is configured with a rectangular shaped open portion (referred to below as a “rectangular opening portion”) 112 and a semi-circular shaped opening portion (referred to below as a “semi-circular opening portion”) 114 (corresponding to retaining portion). The rectangular opening portion 112 is formed with a larger cross-section than the hook portion 96 of the opening 94 of the liquid pack 130, and is a portion that allows the opening 94 to pass through. The semi-circular opening portion 114 is formed smaller than the cross-section of the hook portion 96, and is a portion that is hooked by the hook portion 96 of the opening 94 that has passed through from the rectangular opening portion 112, retaining the opening 94 so as not to be able to come out from the opening section 110. Two claw portions 116 (corresponding to retaining portion) are formed between the rectangular shaped opening portion 112 and the semi-circular shaped opening portion 114 so as to project out towards the direction in which the opening 94 passes. While the rectangular shaped opening portion 112 here is rectangular shaped, configuration may be made with any other shape than rectangular as long as it is larger than the cross-section of the hook portion 96 of the opening 94. Similarly, while the semi-circular shaped opening portion 114 here is semi-circular shaped, configuration may be made with any other shape than semi-circular as long as it is shaped to follow the profile of the opening 94, is hooked by the hook portion 96 of the opening 94 and retains the opening 94 so as not to come out from the opening section 110.

Two individual positioning pins 118 are formed to the bottom plate 98, with a slight rounding applied to the leading ends of the positioning pins 118 that face outwards. The positioning pins 118 are designed to position each of the tank units 42 when mounting the tank units 42 to the seating sections 44. The engaging pin 66 is formed facing outwards on each of the two side plates 100.

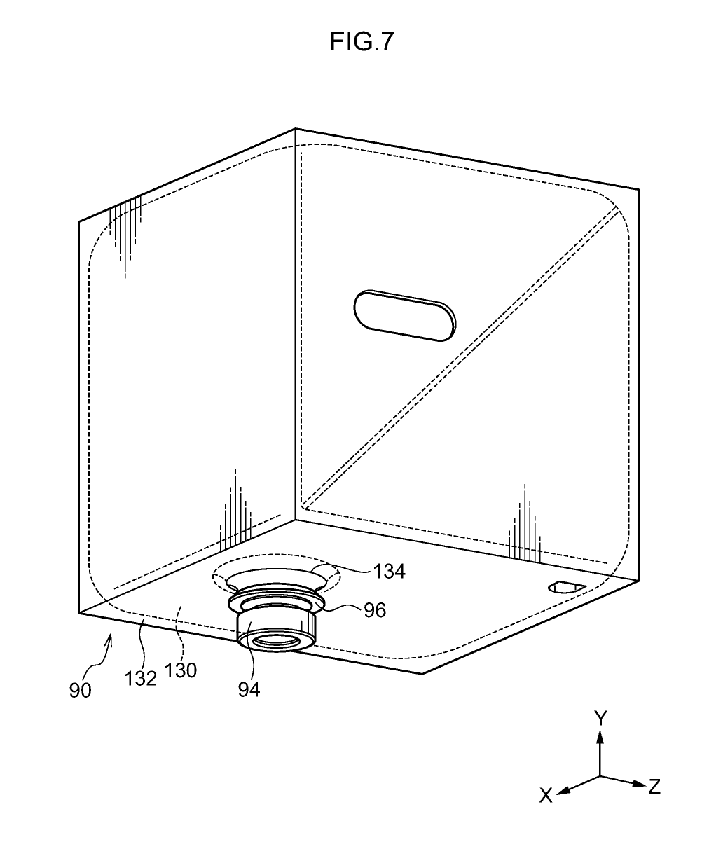

FIG. 7 is a perspective view illustrating the carton unit 90.

The carton unit 90 is formed in a substantially rectangular block shape. The carton unit 90 is configured with a liquid pack (liquid bag) 130 (corresponding to a printing liquid filled container) filled with a liquid (ink) and serving as a printing liquid filled container according to an exemplary embodiment of the present invention, and a carton (paper box) 132 for housing the liquid pack 130. The liquid pack 130 is provided with the opening 94 that serves as a liquid inlet-outlet, and an opening 134 is provided in the carton 132 for externally exposing the opening 94.

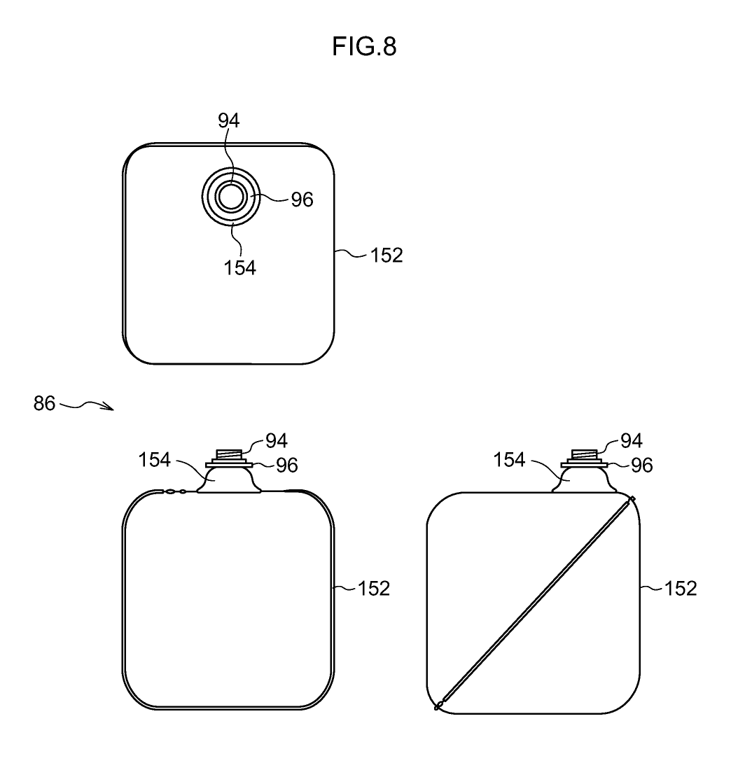

FIG. 8 illustrates a liquid pack 130 serving as a printing liquid filled container according to an exemplary embodiment of the present invention as viewed from 3 faces.

The liquid pack 130 is configured with a liquid housing section 152 formed in a substantially rectangular box shape from a flexible material such as, for example, polyethylene, and the opening 94 that is the liquid inlet-outlet to the liquid housing section 152. The opening 94 is formed from a resin material in a substantially circular cylindrical shape. A funnel shaped portion 154 is formed at a portion of the liquid housing section 152 in a funnel shape so as to extend towards the opening 94. The hook portion 96 is formed to the opening 94 at a position connected to the funnel shaped portion 154 and jutting out from the outer periphery of the opening 94. The opening 94 and the funnel shaped portion 154 are provided at offset positions towards one side (the front side) from the center of one inside face of the 6 faces of the liquid housing section 152.

There are no air holes provided in the liquid pack 130 other than the opening 94, resulting in a configuration such that the liquid pack 130 collapses as liquid is discharged, and liquid can be made to flow out from the opening 94 without gas-liquid replacement.

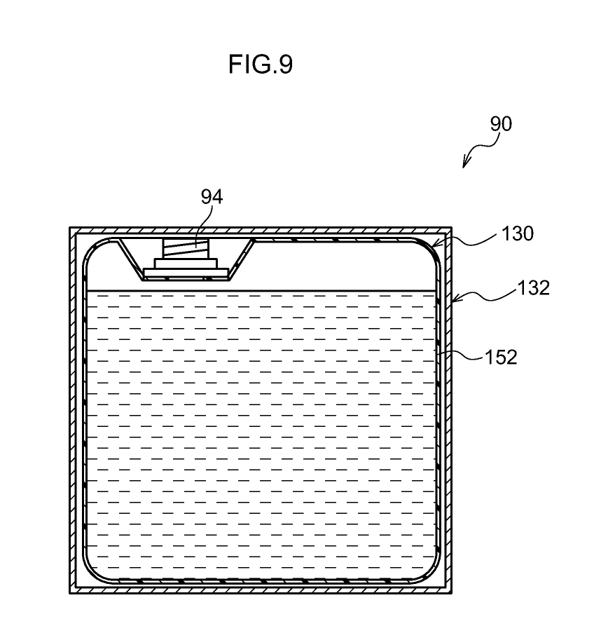

FIG. 9 is a cross-section of the carton unit 90 in which the liquid pack 130 is housed in the carton 132. FIG. 9 illustrates the state during transportation, with the opening 134 for exposing the opening 94 not yet formed in the carton 132.

As shown in FIG. 9, during transporting the liquid pack 130, namely up until starting feeding liquid into the distribution tube 46, both a liquid (ink) and a gas are housed (filled) in the liquid housing section 152 of the liquid pack 130.

In order to reduce the amount of liquid remaining in the liquid housing section 152 to the maximum extent possible, the fill volume of gas inside the liquid housing section 152 is 0.059 or greater by volume with respect to a containable volume capacity of the liquid housing section 152 being 1. From the perspective of suppressing variation in the amount of liquid remaining in the liquid housing section 152 the fill volume of gas is preferably 0.068 or greater, and more preferably 0.091 or greater.
From the perspective of ensuring sufficient liquid discharge volume the gas fill volume is preferably 0.18 or lower.
Note that since a liquid is filled in the liquid housing section 152 in addition to gas, if the gas fill volume is 0.059 for example, then the liquid fill volume is 0.941.

There are no particular limitations to the gas fill pressure and it is, for example, the same as atmospheric pressure.

There are no particular limitations to the type of gas, however when the filled liquid is ink then the gas is preferably a non-reactive gas or inert gas in order to prevent ink deterioration due to oxidization. Non-reactive gas here means a gas that does not undertake an oxidation reaction with combustible by-product gases, namely a gas where there is no danger of fire occurring when mixed with by-product gases. Examples of gases that can be employed as the non-reactive gas include, for example, helium and argon, carbon dioxide and nitrogen, however low cost nitrogen is preferably employed.

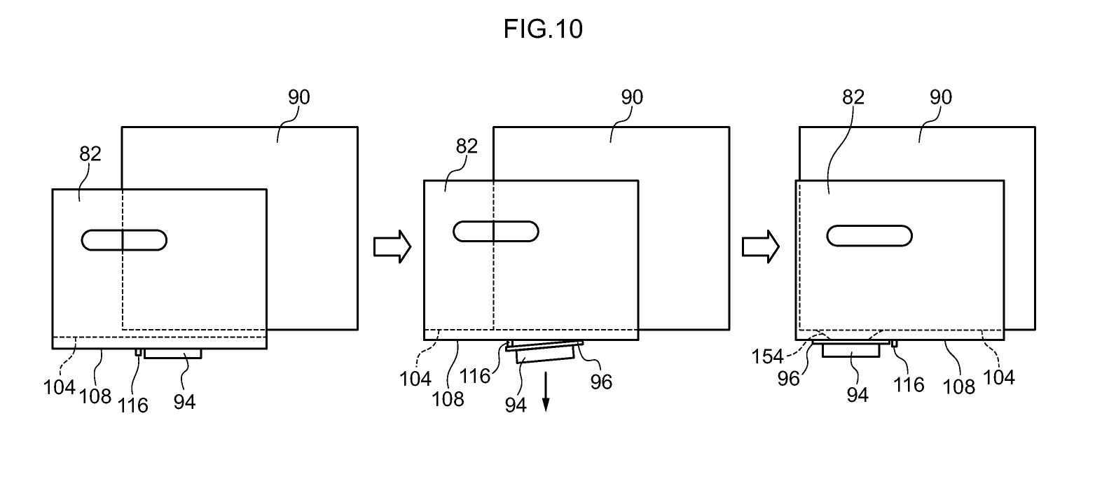

FIG. 10 is an explanatory diagram illustrating states during installing the carton unit 90 to the carton adaptor 92.

After the opening 94 has passed through the rectangular shaped opening portion 112, the opening 94 is moved (slid) up to the semi-circular shaped opening portion 114 while pulling downwards on the opening 94 such that the hook portion 96 of the opening 94 rides over the claw portions 116. Pulling of the opening 94 is ceased at the point when the hook portion 96 of the opening 94 has overridden the claw portions 116, and the opening 94 is retained by the semi-circular shaped opening portion 114 and the two claw portions 116 with the hook portion 96 of the opening 94 in a press-contact state with the two claw portions 116.

Accordingly, the carton adaptor 92 is configured so as to support the bottom face of the carton unit 90 (namely the bottom face of the liquid pack 130) with the support face 104, while the opening 94 of the liquid pack 130 is retained by the retaining portions (the semi-circular shaped opening portion 114 and the claw portions 116) of the stepped face 108 provided below the support face 104 in the direction of gravity. Due to the funnel shape formed on the liquid pack 130 at locations surrounding the opening 94, or more precisely due to the shape of the funnel shaped portion 154 provided surrounding the opening 94 of the liquid pack 130 being maintained, discharge characteristics of liquid from the liquid pack 130 are enhanced.

Whereas in the present exemplary embodiment a configuration is adopted in which the funnel shaped portion 154 is provided in advance to the liquid pack 130, even if the funnel shaped portion 154 is not positively provided to the liquid pack 130, since the retaining portions (the semi-circular shaped opening portion 114 and the claw portions 116) for retaining the opening 94 are provided lower in the direction of gravity than the support face 104 for supporting the bottom face of the carton unit 90 (namely the bottom face of the liquid pack 130) in the carton adaptor 92, a funnel shape naturally forms at locations surrounding the opening 94 of the liquid pack 130, enhancing discharge characteristics of liquid from the liquid pack 130.

While in the present exemplary embodiment the liquid pack 130 is configured so as to be installed to the carton adaptor 92 when housed in the carton 132, even in a configuration in which the liquid pack 130 is installed directly to the carton adaptor 92 without employing the carton 132, since the retaining portions (the semi-circular shaped opening portion 114 and the claw portions 116) for retaining the opening 94 are provided lower in the direction of gravity than the support face 104 for supporting the bottom face of the liquid pack 130 in the carton adaptor 92, a funnel shape naturally forms at locations surrounding the opening 94 of the liquid pack 130, enhancing discharge characteristics of liquid from the liquid pack 130.

The liquid pack 130 is installed in the carton adaptor 92 while housed in the carton 132 because handling of the liquid pack 130 when installing to the carton adaptor 92 is easier with the liquid pack 130 housed in the carton 132 than when the liquid pack 130 is handled on its own, thus facilitating installing the liquid pack 130 in the carton adaptor 92. A step is also readily provided to the support face 104 and the retaining portions, and a face is also readily formed such that only the funnel shaped portion projects out from the opening 134 of the carton 132. Accordingly a funnel shape with good discharge characteristics is better formed at locations surrounding the opening 94 than is the case when the liquid pack 130 is mounted to the carton adaptor 92 on its own without first housing the liquid pack 130 in the carton 132.

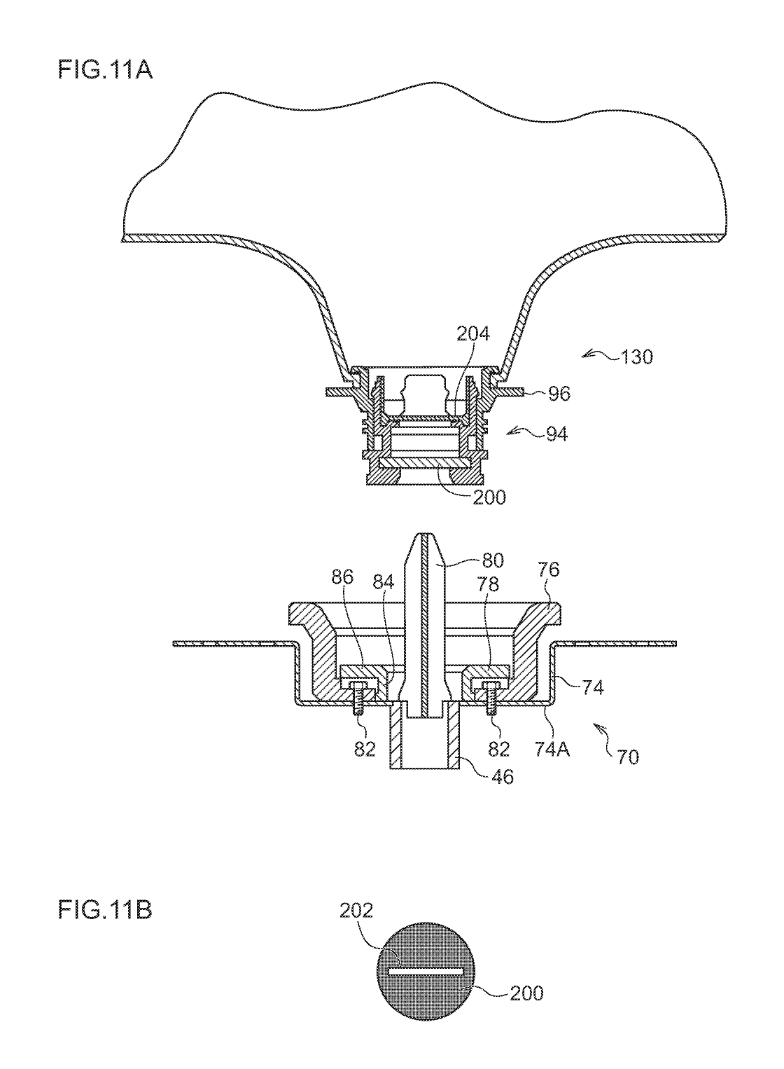

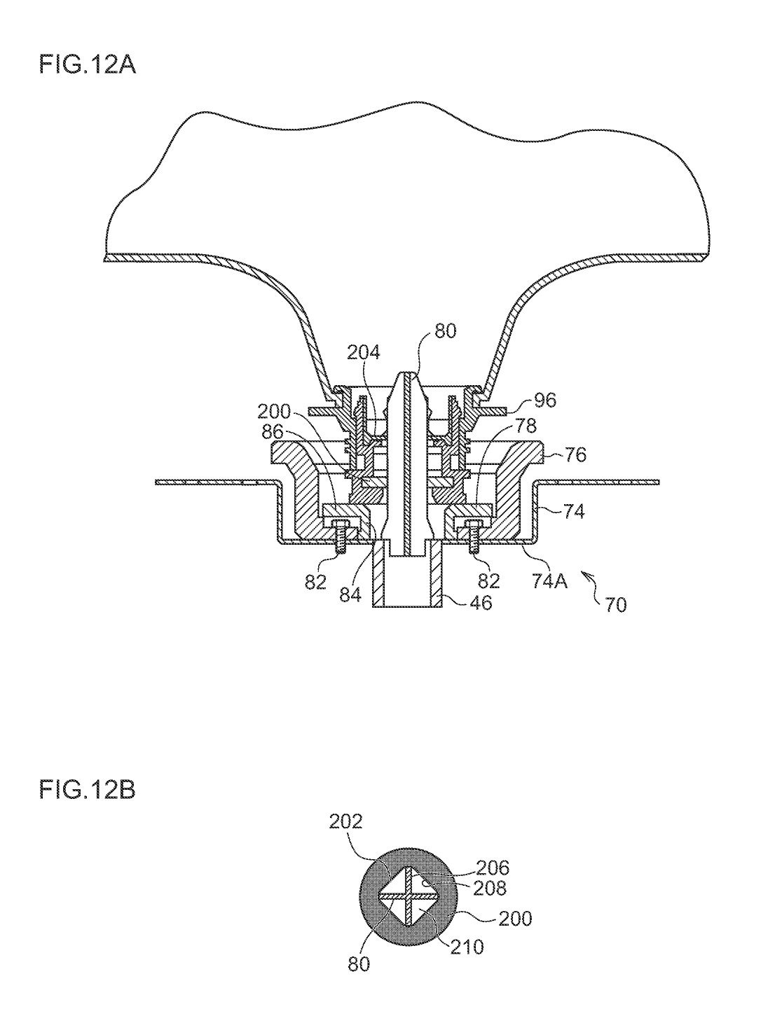

FIG. 11A and FIG. 11B and FIG. 12A and FIG. 12B are cross-sections illustrating details of the hole piercing section 70 and the opening 94 of the liquid pack 130. FIG. 11A is a cross-section illustrating the hole piercing section 70 in a lowered position, in a state prior to being inserted into the opening 94 of the liquid pack 130. FIG. 12A is a cross-section illustrating the hole piercing section 70 in a raised position, in an inserted state in the opening 94 of the liquid pack 130. FIG. 11B is an explanatory diagram illustrating a state of a sealing member 200 provided to an opening 94 of the liquid pack 130 when in the same state as that of FIG. 11A. FIG. 12B is an explanatory diagram illustrating a state of the sealing member 200 when in the same state as that of FIG. 12A.

The sealing member 200 is mounted inside the opening 94 of the liquid pack 130. The sealing member 200 is made from silicone rubber, has resilient properties and is configured in a circular plate shape. A single line shaped slit (incision) 202 is provided at the center of the circular shaped face of the sealing member 200, passing through from one side to the other side. For ease of understanding the width of the slit is shown exaggeratedly large in the diagrams, however the actual slit width is very fine, and liquid is not able to flow out from the slit 202.

A sealing membrane 204 for sealing liquid inside the liquid pack 130 is mounted inside the opening 94 of the liquid pack 130, further towards the opening side than the sealing member 200.

As shown in FIG. 12A and FIG. 12B, when the hole piercing tool 80 is moved upwards and inserted into the opening 94, the slit 202 of the sealing member 200 is pushed out wider into a rectangular shape by the hole piercing tool 80.

Liquid inside the liquid pack 130 starts to flow out downwards when the sealing membrane 204 is ruptured by the hole piercing tool 80. The liquid is guided through a space 210 secured by outer wall faces 206 of the hole piercing tool 80 and inner wall faces 208 of the slit 202 that has been pushed out wider into a rectangular shape, and is fed through the distribution tube 46 to the connected destination that is the main ink tank 21. In comparison to a case in which the hole piercing tool 80 is configured from a hollow needle similar to an injection needle and the liquid is discharged through the hollow portion of the needle, the flow path for discharging the liquid (the space 210) is not formed with flow path walls that obstruct liquid discharge, and liquid does not remain in the vicinity of the opening. Namely, a configuration is achieved in which the flow path (the 206) secured by the outer wall faces 206 of the hole piercing tool 80 and the inner wall faces 208 of the slit 202 contribute to the total discharge of the liquid.

When, from the state shown in FIG. 12A, the hole piercing tool 80 is moved lower and pulled out from the opening 94, the slit 202 of the sealing member 200 reverts to a single line shape, as shown in FIG. 11B. Accordingly, even if any liquid was to remain in the liquid pack 130, such remaining liquid can be prevented from leaking out.

Operation

Explanation follows regarding a case of discharging liquid in the liquid pack 130 from the opening 94, supposing that a gas has not been pre-filled in the liquid pack 130.

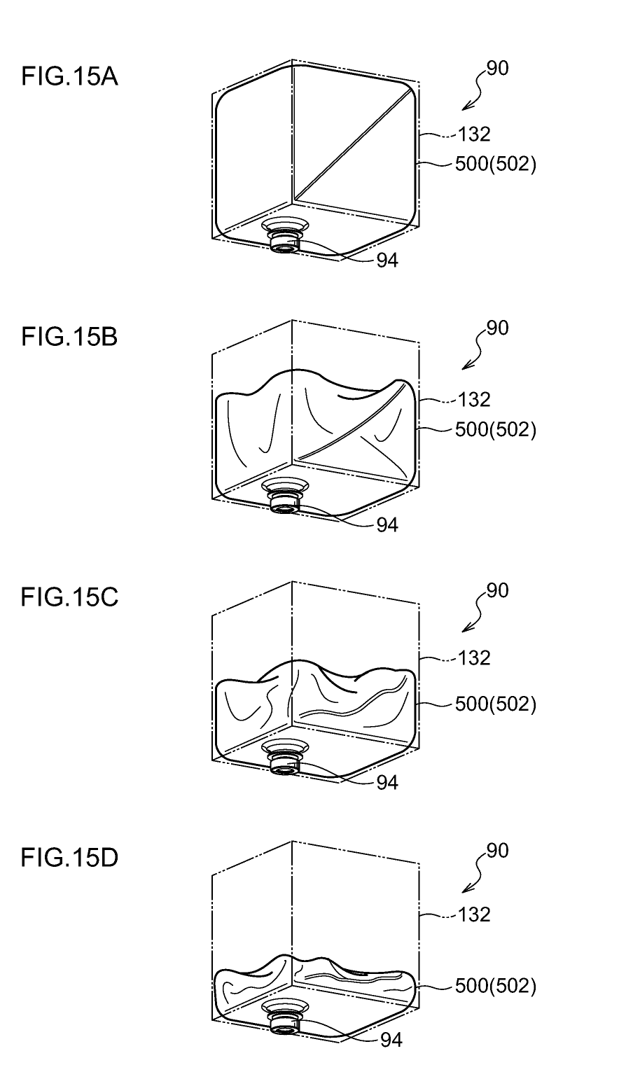

FIG. 15A to FIG. 15D are explanatory diagrams of related technology showing states occurring when liquid in a liquid pack 500 flows out from an opening 94. The liquid pack 500 is provided with a liquid housing section 502 configured from a flexible material, similarly to the liquid pack 130, however gas is not filled in the liquid housing section 502 in contrast to the present exemplary embodiment. Parts of the configuration other than the liquid pack 500 and the liquid housing section 502 are configured similarly to those of the present exemplary embodiment and are allocated with the same reference numerals.

The liquid pack 500 is installed in the inkjet recording apparatus 1 with the opening 94 facing downwards. The sealing membrane 204 of the opening 94 is then ruptured by the hole piercing tool 80, and liquid naturally flows downwards out from the opening 94. Since the liquid housing section 502 of the liquid pack 500 is configured from a flexible material and decreases in capacity according to the discharge amount, as shown in FIG. 15A to FIG. 15D, discharge such as to the main ink tank 21 can be achieved without gas-liquid replacement. However, with such a liquid housing section 502, due to the liquid housing section 502 collapsing (reducing in volume) as discharge progresses, depending on the manner of collapse liquid may be drawn into creases that form due to the collapsing, resulting in an increase in the amount of liquid remaining in the liquid housing section 502.

However, in the present exemplary embodiment both a liquid for printing and a gas are filled in the liquid housing section 152 of the liquid pack 130, and the fill volume of gas is 0.059 or greater with respect to a containable volume capacity of the liquid housing section 152 being 1.

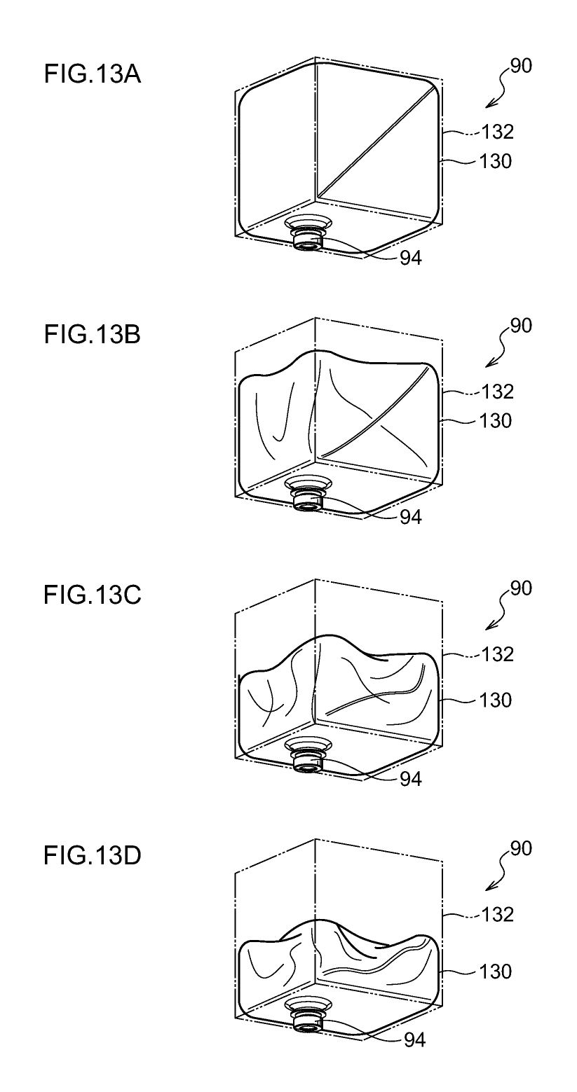

FIG. 13A to FIG. 13D are explanatory diagrams of operation according to an exemplary embodiment of the present invention, illustrating states of discharging liquid in the liquid pack 130 from the opening 94.

According to the configuration of the present exemplary embodiment, when the liquid pack 130 has been installed in the inkjet recording apparatus 1 with the opening 94 facing downwards, the gas rises to the top of the liquid housing section 152, and the liquid flows out from the opening 94 at the bottom of the liquid housing section 152. The liquid housing section 152 then collapses as the liquid flows out from the opening 94 without gas-liquid replacement, however due to the gas filled at the top of the liquid housing section 152, the shape is maintained to some extent as the liquid housing section 152 continues to collapse, as shown in FIG. 13A to FIG. 13D. Accordingly more liquid can be made to flow out from the opening 94 than in cases in which there is no gas filled, and consequently the amount of liquid remaining in the liquid housing section 152 can be reduced.

The maximum reduction in amount of liquid remaining in the liquid housing section 152 can be achieved by setting the gas fill volume to 0.059 with respect to a containable volume capacity of the liquid housing section 152 in the liquid pack 130 being 1.

In the present exemplary embodiment, when the gas filled with the liquid is a non-reactive gas, ink deterioration can be suppressed more than when air is filled with the liquid even when the liquid is an ink that deteriorates through oxidation.

Furthermore, the inkjet recording apparatus 1 provided with the thus configured liquid pack 130 includes the seating sections 44 for installing the liquid pack 130 with the opening 94 facing downwards, and the distribution tubes 46 for feeding the liquid from the seating sections 44 (the openings 94) through the main ink tanks 21Y to 21K to the inkjet heads 10Y to 10K for jetting the liquid onto the recording medium P to form an image. Consequently, more of the liquid inside the liquid housing section 152 can be fed through the opening 94 and the distribution tubes 46 to the inkjet heads 10Y to 10K due to the reduction in the amount of liquid remaining inside the liquid housing section 152 in the liquid pack 130.

### Modified Examples

Note that while the present invention has been explained in detail by way of a particular exemplary embodiment, the present invention is not limited by exemplary embodiment, and it will be obvious to a person of skill in the art that various other exemplary embodiments are possible within the scope of the present invention. For example, appropriate combinations may be implemented from plural features in the above exemplary embodiment. Appropriate combinations may be made with features in the following modified examples.

For example, in the present exemplary embodiment configuration is made such that the liquid pack 130 is installed in the carton adaptor 92 when housed in the carton 132, however the liquid pack 130 may be installed directly in the carton adaptor 92, without employing the carton 132.

In the above “liquid” is not limited to ink, and any liquid for printing may be employed.

Furthermore, in order to reduce the amount of liquid remaining in the liquid housing section 152, configuration may be made such that the internal walls of the liquid housing section 152 are coated so make then slide more feely, or are configured from a freely sliding material.

### EXAMPLES

Explanation follows regarding examples according to the present invention.

In the configuration of the exemplary embodiment described above the liquid housing section 152 of the liquid pack 130 is configured from polyethylene. The containable volume capacity of the liquid housing section 152 is 11 L.

A water based ink for inkjet use is filled as the liquid and air is filled as the gas in a liquid housing section 152 configured as described above. The air fill volume is in the range of 0 to 3 L (in the range of 0 to 0.273 with respect to a containable volume capacity of the liquid housing section 152 being 1). The fill pressure of the air is the same as atmospheric pressure. The liquid fill volume in each Example is the containable volume capacity of the liquid housing section 152 minus the air fill volume.

The sealing membrane 204 is ruptured by the hole piercing tool 80, the opening 94 of the liquid pack 130 is oriented downwards, and the water based ink in the liquid pack 130 is caused to flow out downwards. The opening surface area of the opening 94 of the liquid pack 130 is about 30 mm² when the hole is pierced.

The weight of the liquid pack 130 is measured after the water based ink has finished flowing out, and the amount of ink remaining is derived by subtracting the weight of the liquid pack 130 prior to the ink flowing out. In the present Examples the same Example (same air fill volume) is repeated 4 times in order to investigate reproducibility.

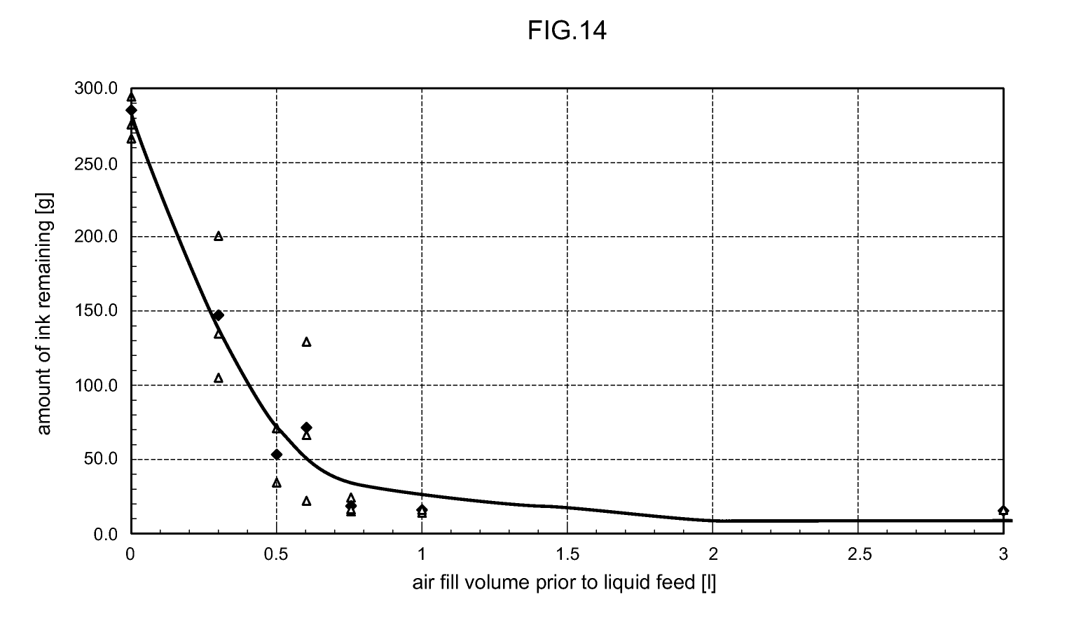

FIG. 14 is a graph illustrating the relationship of amount of ink remaining to air fill volume.

It can be ascertained that there is a point of inflection at an air fill volume of about 0.65 L, and that the amount of ink remaining in the liquid housing section 152 can be reduced to the maximum extent when the air fill volume is at the point of inflection 0.65 L or greater (when the air fill volume is about 0.059 or greater with respect to a containable volume capacity of the liquid housing section 152 being 1).

When the air fill volume is 0.75 L or greater (the air fill volume is about 0.068 or greater with respect to a containable volume capacity of the liquid housing section 152 being 1) then variation in the amount of ink remaining in the liquid housing section 152 can be reliably suppressed.

When the air fill volume is 1 L or greater (the air fill volume is about 0.091 or greater with respect to a containable volume capacity of the liquid housing section 152 being 1) then variation in the amount of ink remaining in the liquid housing section 152 can be even more reliably suppressed.

While the gas employed in the present Examples is air, similar results are obtained when a non-reactive gas is employed.

The printing liquid filled container according to a second aspect of the present invention is the first aspect wherein the gas fill volume is 0.068 or greater.

The printing liquid filled container according to a third aspect of the present invention is the second aspect wherein the gas fill volume is 0.091 or greater.

The printing liquid filled container according to a fourth aspect of the present invention is the third aspect wherein the gas fill volume is 0.18 or less.

The printing liquid filled container according to a fifth aspect of the present invention is any one of the first aspect to the fourth aspect wherein the liquid is an ink and the gas is a non-reactive gas.

An image forming apparatus according to a sixth aspect of the present invention is an image forming apparatus including: an installation section in which the printing liquid filled container of any one of the first aspect to the fifth aspect is installed with the opening facing downwards; and a liquid feed section for feeding the liquid from the installation section to a head section that jets the liquid onto a recording medium and forms an image.

An image forming apparatus according to a seventh aspect of the present invention is the sixth aspect, further including: a surrounding member that is installed to the printing liquid filled container so as to surround at least a portion of the printing liquid filled container, wherein the surrounding member is formed with an opening section for letting the opening pass through and a retaining portion that pulls the opening and retains the opening.

According to a first aspect, when the container is installed to an image forming apparatus with the opening facing downwards, the gas rises up to the top of the container and the liquid flows out from the opening at the bottom of the container. The container collapses as the liquid flows out from the opening without gas-liquid replacement. However, the shape is maintained to some extent as the container collapses, due to the gas filled at the top of the container. Accordingly, more of the liquid can be made to flow out from the opening than is the case when there is no gas filled, enabling the amount of liquid remaining in the container to be reduced. The amount of liquid remaining in the container can be reduced by the maximum extent when the gas fill volume is set as 0.059 or greater with respect to a containable volume capacity of the container being 1.

According to the second aspect, variation in the amount of liquid remaining in the container can be suppressed.

According to the third aspect, variation in the amount of liquid remaining in the container can be suppressed even further.

According to the fourth aspect, the amount of liquid remaining in the container can be reduced while also maximizing the volume of liquid filled.

According to the fifth aspect, since the gas filled with the liquid is a non-reactive gas, ink deterioration can be suppressed more than when air is filled with the liquid even when the liquid is an ink that deteriorates through oxidation.

Due to the reduction in the amount of liquid remaining in the printing liquid filled container of the first aspect, the image forming apparatus according to the sixth aspect is capable of supplying more of the liquid in the printing liquid filled container to the head section, through the opening in the printing liquid filled container, the installation section and the liquid feed section.

According to the seventh aspect, due to a funnel shape being formed at locations surrounding the opening of the container, or more precisely due to the shape of a funnel shaped portion provided surrounding the opening being maintained, discharge characteristics of liquid from a liquid pack can be enhanced.

According to the present invention a printing liquid filled container and an image forming apparatus can be provided to reduce the amount of liquid remaining in a container.

What is claimed is:

1. A printing liquid filled container comprising:
a container that is configured by a flexible material that can let liquid flow out from an opening without gas-liquid replacement and is filled with a liquid for printing and a gas, wherein the gas fill volume is 0.059 or greater with respect to a containable volume capacity of the container being 1.

2. The printing liquid filled container of claim 1 wherein the gas fill volume is 0.068 or greater.

3. The printing liquid filled container of claim 2 wherein the gas fill volume is 0.091 or greater.

4. The printing liquid filled container of claim 3 wherein the gas fill volume is 0.18 or less.

5. The printing liquid filled container of claim 1 wherein the liquid is an ink and the gas is a non-reactive gas.

6. The printing liquid filled container of claim 2 wherein the liquid is an ink and the gas is a non-reactive gas.

7. The printing liquid filled container of claim 3 wherein the liquid is an ink and the gas is a non-reactive gas.

8. The printing liquid filled container of claim 4 wherein the liquid is an ink and the gas is a non-reactive gas.

9. An image forming apparatus comprising:
an installation section in which the printing liquid filled container of claim 1 is installed with the opening facing downwards; and
a liquid feed section for feeding the liquid from the installation section to a head section that jets the liquid onto a recording medium and forms an image.

10. An image forming apparatus comprising:
an installation section in which the printing liquid filled container of claim 2 is installed with the opening facing downwards; and
a liquid feed section for feeding the liquid from the installation section to a head section that jets the liquid onto a recording medium and forms an image.

11. An image forming apparatus comprising:
an installation section in which the printing liquid filled container of claim 3 is installed with the opening facing downwards; and
a liquid feed section for feeding the liquid from the installation section to a head section that jets the liquid onto a recording medium and forms an image.

12. An image forming apparatus comprising:
an installation section in which the printing liquid filled container of claim 4 is installed with the opening facing downwards; and
a liquid feed section for feeding the liquid from the installation section to a head section that jets the liquid onto a recording medium and forms an image.

13. An image forming apparatus comprising:
an installation section in which the printing liquid filled container of claim 5 is installed with the opening facing downwards; and
a liquid feed section for feeding the liquid from the installation section to a head section that jets the liquid onto a recording medium and forms an image.

14. The image forming apparatus of claim 9 further comprising:
a surrounding member that is installed to the printing liquid filled container so as to surround at least a portion of the printing liquid filled container, wherein the surrounding member is formed with an opening section for letting the opening pass through and a retaining portion that pulls the opening and retains the opening.

15. The image forming apparatus of claim 10 further comprising:
a surrounding member that is installed to the printing liquid filled container so as to surround at least a portion of the printing liquid filled container, wherein the surrounding member is formed with an opening section for letting the opening pass through and a retaining portion that pulls the opening and retains the opening.

16. The image forming apparatus of claim 11 further comprising:
a surrounding member that is installed to the printing liquid filled container so as to surround at least a portion of the printing liquid filled container, wherein the surrounding member is formed with an opening section for letting the opening pass through and a retaining portion that pulls the opening and retains the opening.

17. The image forming apparatus of claim 12 further comprising:
a surrounding member that is installed to the printing liquid filled container so as to surround at least a portion of the printing liquid filled container, wherein the surrounding member is formed with an opening section for letting the opening pass through and a retaining portion that pulls the opening and retains the opening.

18. The image forming apparatus of claim 13 further comprising:
a surrounding member that is installed to the printing liquid filled container so as to surround at least a portion of the printing liquid filled container, wherein the surrounding member is formed with an opening section for letting the opening pass through and a retaining portion that pulls the opening and retains the opening.
